(19) United States
(12) Patent Application Publication
(10) Pub. No.: US 2006/0267924 A1
(43) Pub. Date: Nov. 30, 2006

(54) [ELECTRONIC PRODUCT WITH DATA DISPLAY]

(75) Inventor: Wee-Kuan Gan, TAIPEI (TW)

Correspondence Address: PHISON ELECTRONICS CORPORATION, 2F-4. NO. 148, SEC. 4, CHUNG HSIAO EAST ROAD, TAIPEI, TW

(73) Assignee: PHISON ELECTRONICS CORP., Chutung Town, Hsinchu Hsien (TW)

(21) Appl. No.: 11/163,519

(22) Filed: Oct. 21, 2005

(30) Foreign Application Priority Data
May 27, 2005 (TW) 094117579

(51) Int. Cl. G09G 3/36

(52) U.S. Cl. 345/104

(57) ABSTRACT

An electronic product with the data display is disclosed. The electronic product comprises a cholesteric liquid crystal, a controller and a execution program. The controller is adopted for commanding the cholesteric liquid crystal to display pictures or words, wherein the cholesteric liquid crystal is adopted to receive commands transmitted from the controller for displaying the pictures or words. The execution program is adopted for receiving command from a host and converting the commands into an acceptable format for the controller, wherein when the host commands to display the pictures or words to the electronic product, the commands are transmitted to the execution program in the electronic product and the execution program converts the commands into an acceptable format for the controller and transmits to the controller, and the controller transmits the pictures or words to the cholesteric liquid crystal for display.

### BACKGROUND OF THE INVENTION

1. Field of the Invention

The present invention generally relates to an electronic product with data display, and more particularly to an electronic product in which a cholesteric liquid crystal is utilized to display the pictures or the words so that the user may visually learn the status of the electronic product. Besides, the last displayed pictures or words are displayed when the electronic product is in sleep mode, thus the user may visually learn the latest status of the electronic product without turning on the electronic product.

2. Description of Related Art

With the progressive improvement in electronic technology, the electronic products such as computer, cellular phone, memory stick, digital camera are widely used in our daily life. And, increased functions of the electronic products have changed our life styles accordingly. It is common nowadays that the user possesses several sets of the same electronic products, for example, the memory stick, the memory card and other electronic products with the storage function. Because these products have limited storage capacity, therefore users usually purchase a plurality of sets for use. However, these electronic products need to turned on to learn the stored files, the used capacity or the storage capacity available for use, and the user has to memorize these information or to prepare a label indicating these information on the electronic product in order to make sure whether the available storage capacity for use is sufficient for the next time. However, using the human memory to memorize the stored files, used storage capacity or available storage capacity for use of the electronic product is not reliable as user often forgets or misunderstands the information, and therefore, the electronic product has to be turn on to check. The above-mentioned inconvenience may cause substantial amount of energy wastage and also adversely affect the service life the electronic products due repeated turning on and off. However, using label including the latest status of the electronic product may be helpful to remind the user, but it ruins the appearance of the product, and the label may easily fall off. Therefore, to use the label to mark the status information of the electronic product is not really a good method.

At present, the consumers usually purchase popular products such as cellular phone, PDA or digital camera on the market; therefore several users may often possess the same kind of electronic products that could easily cause misunderstandings as to the ownership.

Furthermore, the electronic products all have the model number, the accessory and the functions labeled on the case. For clearly showing to the user, the color of the description remark thereof must be other than the case, thus the outlook of the electronic product is affected. And the color of the description remark fades away gradually to be unclear to the user to identify. Besides, the electronic products with the same outlook may designed to have different functions and to have different model number, in this case, the manufacturers have to use different module to print the remark to accordingly increase the manufacturing cost.

The technology is being developed to satisfy the great need of the liquid crystal display, and the cholesteric liquid crystal is developed to provide the advantageous features such as memory, Multi-Domain Vertical Alignment and non-twinkle. The power consumption of the cholesteric liquid crystal is 1/50 or less than the conventional LCD. Such cholesteric liquid crystal only consumes power when the crystal orientation changes while displaying. In other words, when the display is still, no power will be consumed. Therefore, the cholesteric liquid crystal is capable of continuously displaying the last picture without consuming any power, and even when the power supply to the cholesteric display is cut off.

With the above advantages of the cholesteric liquid crystal, it is highly desirable to apply the cholesteric liquid crystal into the electronic products with data display.

### SUMMARY OF THE INVENTION

Accordingly, in the view of the foregoing, the present inventor makes a detailed study of related art to evaluate and consider, and uses years of accumulated experience in this field, and through several experiments, to create a new electronic product with data display.

According to an aspect of the present invention, the electronic product comprises a cholesteric liquid crystal, wherein when the electronic product is connected to a host, the host commands to the electronic product to display the last pictures or words via the cholesteric liquid crystal. The programmer or the user may use the cholesteric liquid crystal as a built-in label including the information of the electronic product, such as the model number, accessory or functions. Thus, the printing cost for the manufacturers may be substantially reduced.

According to another aspect of the present invention, when the user uses the electronic product comprising the cholesteric liquid crystal, the data and the latest status of the electronic product is displayed on the cholesteric liquid crystal so that the user may visually learn the latest status of the electronic product even before turning on the electronic product.

According to yet another aspect of the present invention, the electronic product comprising the cholesteric liquid crystal comprises an execution program and an input device, wherein the execution program comprises one or more pre-programmed pictures or data, and the execution program may be controlled by using the input device to display the pre-programmed pictures or words on the cholesteric liquid crystal, as well as alter the displayed information.

### BRIEF DESCRIPTION OF THE DRAWING

For a more complete understanding of the present invention, reference will now be made to the following detailed description of preferred embodiments taken in conjunction with the following accompanying drawings.

FIG. 1 is a block diagram according to a preferred embodiment of the present invention.

FIG. 2 is a block diagram according to another preferred embodiment of the present invention.

### DETAILED DESCRIPTION OF EMBODIMENTS

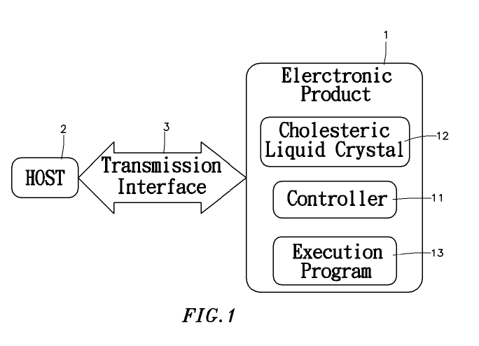

Referring to FIG. 1, an electronic product 1 in accordance with the present invention is shown comprised of a controller 11, a cholesteric liquid crystal 12 and an execution program 13.

The controller 11 is adopted for commanding the cholesteric liquid crystal 12 to display pictures or words as desired.

The cholesteric liquid crystal 12 is adopted for receiving a command from the controller 11 for displaying pictures or words.

The execution program 13 is connected to a host 2 via a transmission interface 3 and the host 2 reads the execution program 13 stored in the electronic product 1 via the transmission interface 3 and executes the execution program 13 to command to the electronic product 1.

When the host 2 commands the electronic product 1 to displaying pictures or words, a command is transmitted via the transmission interface 3 to the controller 11 of the electronic product 1, and the pictures or words are displayed in the cholesteric liquid crystal 12 when the controller 11 receives the command. If the user wishes to alter the displayed pictures or words in the cholesteric liquid crystal 12, the host 2 may command to change the display only via the execution program 13.

Accordingly, the programmer or the user may use the cholesteric liquid crystal 12 as a built-in label of the electronic product 1 for displaying the model number, the accessory or the functions of the electronic product 1. Thus, the user may visually learn the operation method or the model number of the electronic product 1. When operating electronic product 1, the execution program 13 controls the controller 11 to display the information and the status of the electronic product 1 in the cholesteric liquid crystal 12. Besides, because the cholesteric liquid crystal 12 has the advantageous features, such as memory, Multi-Domain Vertical Alignment and non-twinkle, and the power consumption of the cholesteric liquid crystal 12 is merely 1/50 of the conventional LCD or even less. Such cholesteric liquid crystal 12 only consumes power when the crystal orientation changes while displaying. In other words, no power is consumed when the display is still. Therefore, the cholesteric liquid crystal 12 can display the last picture even when the electronic product 1 is in sleep mode.

Furthermore, the cholesteric liquid crystal 12 may also be used to display the user's personal information via the controller 11 to prevent misunderstanding with other user's electronic products 1.

The electronic product 1 may be a cellular phone, a memory stick, a MP3 player or a PDA, and the transmission interface 3 may be an USB, an IEEE1394 or a PCI.

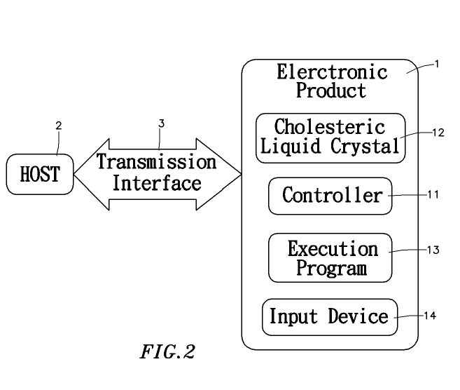

Referring to FIG. 2, the execution program 13 may adopted for pre-programming one or more pictures or data, and an input device 14 of the electronic product 1 may adopted to command to the controller 11 to display the pre-programmed pictures or words in the cholesteric liquid crystal 12 as well as alter the displayed information. The input device 14 may be a keyboard or a voice controlled device.

Furthermore, during the sleep mode of the electronic product 1, the one or more pre-programmed pictures or data may be displayed in the cholesteric liquid crystal 12, which may be controlled via the controller 11, to make the electronic product 1 look attractive to the user to promote sale.

Accordingly, the electronic product with data display of the present invention has at least the following advantages.

1. When the electronic product is connected to the host via the transmission interface, the host commands to the electronic product to display pictures or words. The host reads the execution program in the electronic product and executes the execution program to transmit the command to the electronic product; the controller receives the command and makes the cholesteric liquid crystal display pictures or words. The programmer or the user may use the cholesteric liquid crystal as a built-in label to display the product information such as model number, accessory or functions. Thus, the printing cost for the manufacturers can be substantially reduced.

2. The cholesteric liquid crystal in the electronic product is capable of displaying the information and the status of the electronic product so that the user may visually learn the above-mentioned information. The cholesteric liquid crystal comprises memory to display the last pictures or words even when the electronic product is in sleep mode.

3. By operating the cholesteric liquid crystal, the controller and the input device of the electronic product, the desired pictures or data may be pre-programmed and displayed by the cholesteric liquid crystal, and the pre-programmed pictures or data may be also be altered.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What is claimed is:

1. An electronic product with data display, comprising:
a cholesteric liquid crystal;
a controller, adopted for commanding said cholesteric liquid crystal to display pictures or words, wherein said cholesteric liquid crystal is adopted to receive commands transmitted from said controller for displaying said pictures or words; and
an execution program, for receiving command from a host and converting said command into an acceptable format for said controller, wherein when said host commands to display said pictures or words to said electronic product, said command is transmitted to said execution program in said electronic product and said execution program converts said command into an acceptable format for said controller and transmit to said controller, and said controller transmits said pictures or words to cholesteric liquid crystal for display.

2. The electronic product with data display according to claim 1, wherein said electronic product is connected to said host via a transmission interface.

3. The electronic product with data display according to claim 2, wherein said transmission interface comprises an USB.

4. The electronic product with data display according to claim 2, wherein said transmission interface comprises a PCI.

5. The electronic product with data display according to claim 1, wherein said electronic product comprises a cellular phone.

6. The electronic product with data display according to claim 1, wherein said electronic product comprises a memory stick.

7. An electronic product with data display, comprising:
a cholesteric liquid crystal;
a controller, adopted for commanding said cholesteric liquid crystal to display pictures or words, wherein said cholesteric liquid crystal is adopted to receive commands transmitted from said controller for displaying said pictures or words; and
an execution program, for transmitting information or status of said electronic product to said controller during operation, wherein said controller transmits said information or status of said electronic product to display via said cholesteric liquid crystal so that user can visually learn said information or status of the electronic product during operation.

8. The electronic product with data display according to claim 7, wherein said electronic product comprises a cellular phone.

9. The electronic product with data display according to claim 7, wherein said electronic product comprises a memory stick.

10. An electronic product with the data display, comprising:
a cholesteric liquid crystal;
a controller, adopted for commanding said cholesteric liquid crystal to display pictures or words, wherein said cholesteric liquid crystal is adopted to receive commands transmitted from said controller for displaying said pictures or words; and
an execution program, comprising one or more pre-programmed pictures or data, wherein said execution program is controlled by a input device to display said pre-programmed pictures or data in said cholesteric liquid crystal.

11. The electronic product with data display according to claim 10, wherein said electronic product comprises a cellular phone.

12. The electronic product with data display according to claim 10, wherein said electronic product comprises a memory stick.

13. The electronic product with data display according to claim 10, wherein said input device comprises a keyboard.

14. The electronic product with data display according to claim 10, wherein said input device comprises a voice controlled device.
